(19) United States
(12) Patent Application Publication
(10) Pub. No.: US 2009/0102850 A1
(43) Pub. Date: Apr. 23, 2009

(54) Error Diffusion for Display Frame Buffer Power Saving

(75) Inventors: Luhong Liang, Beijing (CN); Xiaoying He, Beijing (CN); Rui Chen, Shenzhen (CN)

Correspondence Address: BLAKELY SOKOLOFF TAYLOR & ZAFMAN LLP, 1279 OAKMEAD PARKWAY, SUNNYVALE, CA, 94085-4040, US

(73) Assignee: INTEL CORPORATION, Santa Clara, CA (US)

(21) Appl. No.: 10/576,172

(22) PCT Filed: Sep. 29, 2005
(86) PCT No.: PCT/CN2005/001620

§ 371 Date: Jan. 6, 2009

(51) Int. Cl. G09G 5/36

(52) U.S. Cl. 345/545

(57) ABSTRACT

Methods and apparatuses for error diffusion for display frame buffer power saving are described herein. According to one embodiment, pixels of a color plane of image data are stored in a first segment and a second segment of a frame buffer during a normal power state. During a low power state, an error diffusion operation is performed on the pixels to reduce a color depth of the pixels. Thereafter, at least a portion of the pixels with reduced color depth is stored in the first segment of the frame buffer during the low power state without accessing the second segment of the frame buffer. Other methods and apparatuses are also described.

### FIELD

Embodiments of the invention relate to data processing systems; and more specifically, to error diffusion for display frame buffer of a data processing system.

### BACKGROUND

Today, pocket-PCs, PDAs (Personal Data Assistants), mobile phones, digital cameras and camcorders are equipped with color TFT (Thin-Film Transistor) LCDs (Liquid Crystal Displays), power-efficient STN (Super-Twisted Nematic) LCD or OLED (Organic Light-Emitting Diode). A display sub-system has become a major energy consumer even though the systems are equipped with a powerful CPUs and with a tens of MBs of SDRAM. In both LCD and OLED, a frame buffer is an indispensable ingredient which consumes a large portion of the energy.

One of the low power frame buffer techniques is the dynamic-color-depth control technique, in which a new pixel organization is proposed to enable the shut down the LSD (least significant device) of the frame buffer. In this case, the power consumption of the frame buffer memory and the associated logic is reduced. However, this technique causes obvious false contour artifacts in the image/video.

Other techniques have been proposed for power reduction in display sub-system, including variable duty-ratio refresh by reducing the refresh rate of a frame buffer and brightness and contrast shift by dimming backlight luminance and adjusting the image luminance synchronously. However, these techniques cause obvious image/video quality degeneration.

In addition, a halftoning-based technique has been proposed to reduce the frame buffer for handset application. In this technique, the original 24-bit RGB color data is converted to 18-bit or 15-bit color data, and ordered dithering technique is used to remove the false contour artifacts caused by quantization. However, it produces artifacts of patterns introduced by fixed thresholding matrices.

Further, a frame buffer compression technique has been proposed for reducing power consumption of a display sub-system. In this technique, a frame buffer is separated into an uncompressed page and a compressed page. The original data is initially sent into the uncompressed page during a normal power mode. In a low power mode, an encoder compresses the original data into the compressed page, and the LCD panel refreshing operations only access the compressed page with much less bits. Therefore, the number of frame buffer bit access is reduced as well as the corresponding power consumption. However, this technique is not efficient in images.

Furthermore, an error diffusion technique has been widely used in the printing field. Error diffusion technique is a specific method of halftoning that represents more color using small number of color. In this technique, the algorithm functions are performed on each image pixel. For the red, green, and blue components of each pixel, an error between the original and quantized values is computed. The error that is determined to occur at the central pixel is then distributed among the surrounding pixels. However, this technique involves complex computation which may require a relatively large processing power.

### BRIEF DESCRIPTION OF THE DRAWINGS

Embodiments of the invention may best be understood by referring to the following description and accompanying drawings that are used to illustrate embodiments of the invention. In the drawings:

FIG. 1 illustrates various images as results of conventional methods and methods according to certain embodiments.

FIG. 2 is a diagram illustrating a data format of a frame buffer according to one embodiment.

FIGS. 3-5 are block diagrams illustrating various embodiments of display subsystems.

FIG. 6A is a flow diagram illustrating a process example of a display subsystem according to one embodiment.

FIG. 6B is a flow diagram illustrating a process example of an error diffusion operation according to one embodiment.

FIG. 7 is a pseudo code of a process for an error diffusion operation according to one embodiment.

FIG. 8 is a flow diagram illustrating a process example of an error diffusion operation according to another embodiment.

FIG. 9 is a pseudo code of a process for an error diffusion operation according to another embodiment.

FIG. 10 is a block diagram illustrating an example of a data processing system that may be used as an embodiment.

### DETAILED DESCRIPTION

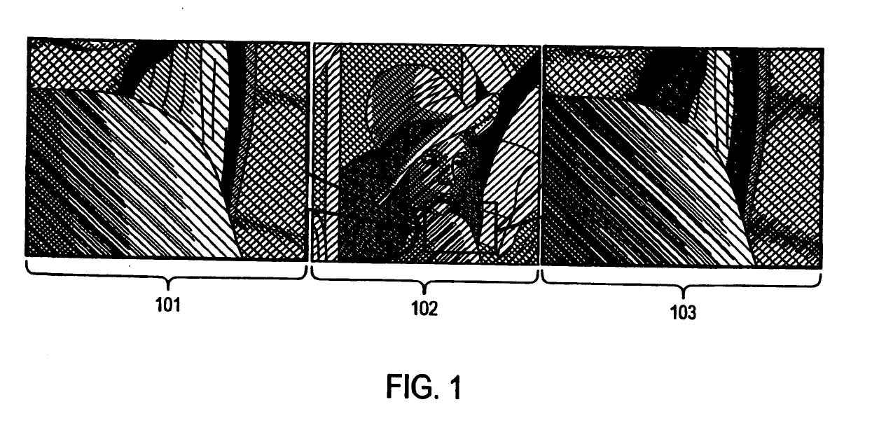

Methods and apparatuses for error diffusion for display frame buffer power saving are described herein. According to certain aspects of the invention, an effective low power display techniques are employed by shutting down the LSD of the frame buffer memory while preserving the image quality. According to one embodiment, a simplified error diffusion algorithm (for example, implemented as an Error Diffusion Encoder) is utilized that encodes the images with full color depth to the ones with reduced color depths without generating false contour artifacts as shown in image 103 generated from image 102 of FIG. 1. The Error Diffusion Encoder can be implemented in a display driver, application software, and/or in hardware modules, such as a display controller, GMCH (graphics and memory control hub), and/or equivalent chips.

Compared with a conventional dynamic-color-depth control technique, the technique described herein is able to overcome the false contour artifacts caused by the directly shutting down the LSD of frame buffer memory, as shown image 101 generated from image 102 of FIG. 1. Compared with the conventional run-length-coding frame buffer compression technique, the technique described herein is much more efficient for the image and video content as well as the text and graphics contents. While the conventional technique is only efficient for text and simple graphics contents, since the run-length-coding algorithm is not able to compress the image and video contents very efficiently, which causes the power saving for image and video is very limited. Compared with the conventional dithering technique, the complexity of the technique described herein is much lower and is able to reduce the color depth, for example, from 24 bits to 8 or 9 bits, while the conventional technique just reduces the color depth to 15 or 18 bits.

In the following description, numerous details are set forth to provide a more thorough explanation embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment. Reference in the specification to “image” means image, one frame of video, or 2D/3D graphics contents stored in image data format for display.

According to one embodiment, an error diffusion mechanism is proposed to process the image data writing into the frame buffer memory, in order to remove these artifacts while saving the power consumption at the same time.

In one embodiment, an error diffusion encoder may be implemented in a display sub-system hardware and/or software to remove the image artifacts when the LSD of frame buffer memory is shut down for power reduction. In addition, according to one embodiment, a 2-neighborhood error filter and the error-bit-reduction approach are utilized to reduce the computational complexity of the classical error diffusion algorithm to reduce the energy consumption and cost of the error diffusion encoder. Further, certain software and/or hardware embodiments of the Error Diffusion Encoder may be utilized to provide a low power work mode of the display sub-system. Although an error diffusion encoder may be implemented in a display controller, similar designs may be applied to display sub-systems with different color depth and data storage format to achieve the similar functionality.

An image with large number of colors can be represented by small number of colors without false contour artifacts using the error diffusion technique. In one embodiment of the invention, the error diffusion technique is used to represent an original image with full color depth by pixels with reduced color depth. In a particular embodiment, the modified algorithm acts as an encoder (e.g., Error Diffusion Encoder) to translate the original image to the image with lower color depth to fit with the MSD of the frame buffer, when it is required to shut down or reduce power of the LSD of the frame buffer memory to reduce the power consumption.

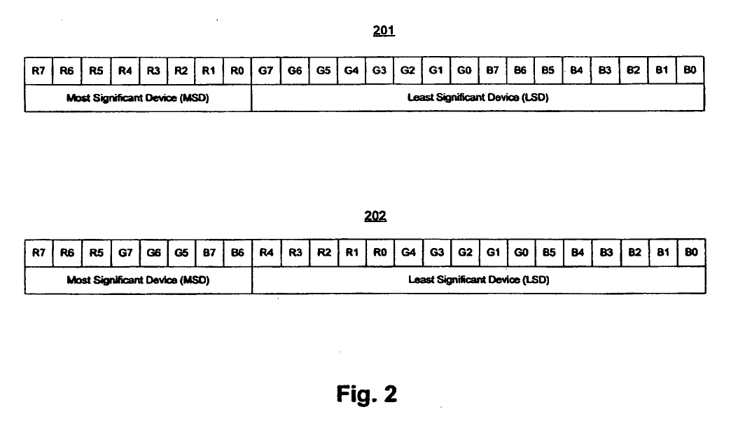

According to one embodiment, the bit order in a frame buffer may be reorganized. Referring to FIG. 2, the conventional physical structure 201 includes a 24-bit color pixel. Suppose the color depth of the pixel is compressed to 8-bit (3-bit, 3-bit and 2-bit for R, G and B respectively) in the low power work mode, the physical structure of the pixel bits can be re-organized as 202, in which the MSD and the LSD can be implemented, for example, in different memory banks. Therefore the shut down of the LSD can be achieved. Different to the conventional dynamic-color-depth control technique, an embodiment of the method adds a simplified error diffusion module (Error Diffusion Encoder) in a display driver, display controller, and/or equivalent hardware modules (e.g., software, hardware, or a combination of both) to remove the image artifacts caused by the reduced color depth.

The Error Diffusion Encoder can be implemented in a display driver and/or application software, for example, running within a processor or controller (e.g., firmware, DSP or a CPU, etc.) The modified display data is fed into the MSD when the LSD is shut down or the power of the LSD is reduced.

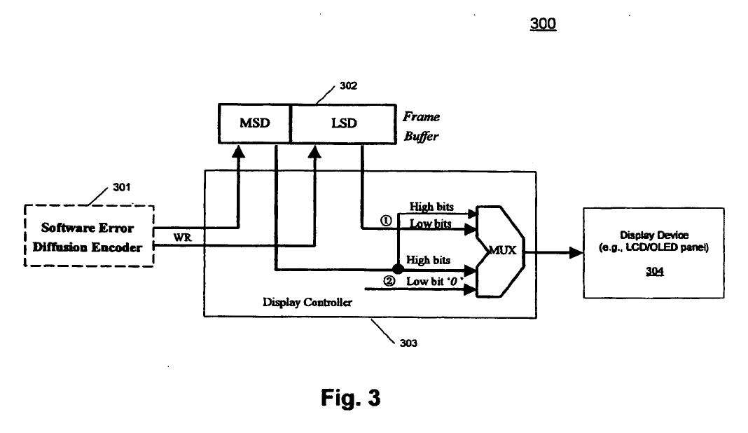

FIG. 3 is a block diagram illustrating a display sub-system according to one embodiment of the invention. In one embodiment, display system 300 includes, but is not limited to, an error diffusion encoder 301 coupled to a frame buffer 302 and a display controller 303 which is coupled to a display device 304, such as, for example LCD or OLED display panel. In this embodiment, an error diffusion encoder 301 may be implemented as a software encoder, which may be implemented as an application, device driver, and/or firmware. Frame buffer 302 may be a specifically allocated memory from a main memory (not shown). Alternatively, frame buffer 302 may be a dedicated memory within a chipset (e.g., memory controller, not shown) or a display controller 303. Furthermore, frame buffer 302 may be a dedicated standalone memory chipset in the display subsystem. The display controller 303 may be implemented within a chipset or a standalone display controller (e.g., PCI (peripheral component interconnect), PCI-Express or AGP (accelerated graphic port) compatible controller). In one embodiment, software diffusion encoder 301 processes the display data and stores the processed display data in the frame buffer 302. Thereafter, the display controller 303 fetches the data from the frame buffer and sends the display data to the display device 304 for display.

Referring to FIG. 3, according to one embodiment, the display sub-system 300 provides two display modes: 1) the normal work mode or a tint powermode, and 2) the low power work mode. In the normal work mode, the original display data is directly fed into the frame buffer with bit order similar to bit order 202 of FIG. 2 without any change. The display controller 303, controlled by software (e.g., including error diffusion encoder 301), may choose path (1) to access the full frame buffer for the display panel refreshing. While in the low power work mode, the software Error Diffusion Encoder 301 translates the original image to pixels with reduced color depth that fits with the size and organization of the MSD without generating false contour artifacts, and then writes the result data into the MSD of the frame buffer 302. When the display controller 303 refreshes the display device 304, it just fetches the data out from MSD of the frame buffer 302 through path (2) and feeds the data to the display device 304, and considers the data of least significant bits as zero or a predetermined value.

In the low power work mode, only the MSD of the frame buffer and the associated logics are powered, all other parts (e.g., LSD of the frame buffer) can be powered down. According to one embodiment, a color image with 24-bit or 16-bit color depth can be converted to 9-bit (e.g., 3 bits for each color) or 8-bit (e.g., 3 bits for R and G, 2 bits for B) without obvious artifacts. Therefore this embodiment is able to shut down approximately 43%˜66% of the frame buffer to save approximately 43%˜66% of the power consumption of the display sub-system. This embodiment is typically useful for those applications where the image content changes relatively slowly, such as, for example, those applications including e-book, image/text editor, web browser, etc.

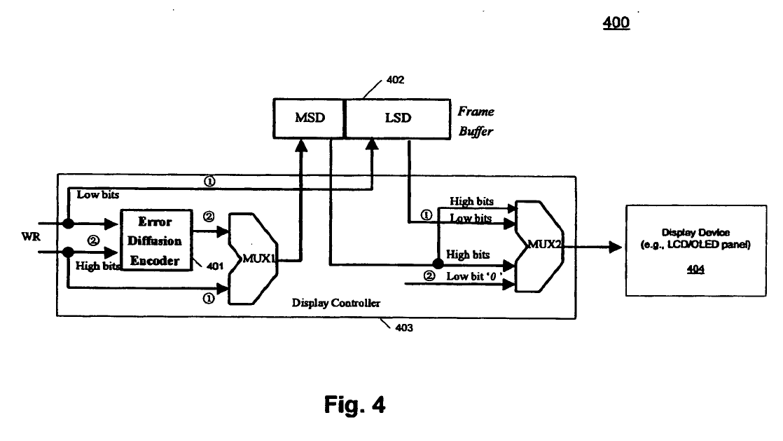

FIG. 4 is a block diagram illustrating a display sub-system according to another embodiment of the invention. In this embodiment, an Error Diffusion Encoder may be implemented in hardware. For example, the error diffusion encoder may be implemented as part of a display controller and/or a chipset. In one embodiment, display system 400 includes, but is not limited to, an error diffusion encoder 401 implemented within a display controller 403 which is coupled to one or more frame buffers 402 and a display device 404, such as, LCD or OLED display panel. Frame buffer 402 may be a specifically allocated memory from a main memory (not shown). Alternatively, frame buffer 402 may be a dedicated memory within a chipset (e.g., memory controller, not shown) or a display controller 403. Furthermore, frame buffer 402 may be a dedicated standalone memory chipset in the display subsystem. The display controller 403 may be implemented within a chip set or a standalone display controller (e.g., PCI, PCI-Express or AGP compatible controller). In one embodiment, error diffusion encoder 401 processes the display data and stores the processed display data in the frame buffer 402. Thereafter, the display controller 403 fetches the data from the frame buffer 402 and sends the display data to the display device 404 for display.

FIG. 4 illustrates an example of a display controller implementation, in which a hardware module performs the error diffusion algorithm in addition to the re-organization of the frame buffer bits. In a normal work mode, referring to FIG. 4, the data stream follows the path (1), through which the original image data are written into both MSD and LSD of the frame buffer 402, and are fully accessible for display panel refreshing. In the low power work mode, the data stream follows path (2). The Error Diffusion Encoder 401 translates the original image to pixels with reduced color depth that fits with the size and organization of the MSD without generating false contour artifacts, then writes the result data into MSD. In the low power mode, the power to the LSD may be removed or reduced.

When the display controller 403 refreshes the display device 404, the display controller 403 just fetches out the data from MSD through path (2) and considers the data of least significant bits as zero or a predetermined value. Apparently, in this case, the same portion of the frame buffer memory (e.g., the LSD) and the associated bus lines can be powered down. In this embodiment, the hardware simulation results show the power consumption of the Error Diffusion Encoder is potentially as low as 0.05% of the frame buffer memory, which may be neglected when calculating the power saving of the system. Therefore approximately 43%˜66% of the power consumption of the frame buffer and the associated logic can be reduced in this embodiment. This embodiment is typically useful for all kinds of applications, such as text viewer, image viewer, movie player and so on.

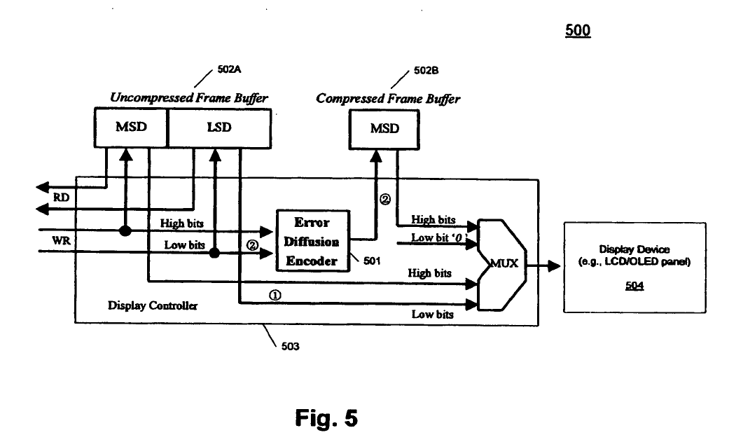

According to a further embodiment, multiple frame buffers or frame buffer sections may be used. FIG. 5 is a block diagram illustrating a display sub-system according to another embodiment of the invention. In this embodiment, multiple frame buffers or frame buffer sections are implemented. In one embodiment, display system 500 includes, but is not limited to, an error diffusion encoder 501 implemented within a display controller 503 which is coupled to multiple frame buffers 502A-502B and a display device 504, such as, LCD or OLED display panel.

Frame buffers 502A and 502B may be a specifically allocated memory from a main memory (not shown). Alternatively, frame buffers 502A and 502B may be a dedicated memory within a chipset (e.g., memory controller, not shown) or a display controller 503. Furthermore, frame buffer 502A and 502B may be a dedicated standalone memory chipset in the display subsystem. In a particular embodiment, frame buffers 502A and 502B may be individually powered up and down. The display controller 503 may be implemented within a chipset or a standalone display controller (e.g., PCL PCI-Express or AGP compatible controller). In one embodiment, error diffusion encoder 501 processes the display data and stores the processed display data in the frame buffers 502A and 502B. Thereafter, the display controller 503 fetches the data from the frame buffers 502A and 502B, and sends the display data to the display device 504 for display.

Referring to FIG. 5, in one embodiment, the Uncompressed Frame Buffer (IJFB) 502A is used to store the original image pixels during a normal power mode (also referred to as a first power state), while an additional Compressed Frame Buffer (CFB) 502B is used to store the result image with low bit depth for the low power work mode. The UFB 502A has both MSD and LSD that may be organized in traditional bit order 201 or proposed bit order 202 shown in FIG. 2. The CFB 502B only has MSD with similar size as the MSD in the configuration shown in FIG. 4. In the normal work mode, according to one embodiment, the image data are written into the UFB 502A, and then read out through the path (1) for display panel refreshing.

While in low power work mode (also referred to as a low power state or a second power state), the Error Diffusion Encoder 501 translates the original image to pixels with a lower color depth that fits with the size and organization of the CFB without generating false contour artifacts, then writes the result data into the CFB 502B. Meanwhile, the original image data are also written into the UFB 502A for future read-back. When the display controller 503 refreshes the display device 504, it just reads out the data from CFB 502B through path (2) and considers the data of least significant bits as zero or a predetermined value.

This embodiment provides a transparent interface to the host system in both frame buffer read and write. In this example, the low power work mode may consume more energy than the normal work mode in the frame buffer writing, since the Error Diffusion Encoder 501 and the CFB 502B consumes additional energy. But the display device refreshing consumes less power due to smaller size of CFB 502B and associated logics. As a result, this embodiment is typically useful for those applications where the image content changes very slowly. Such sample applications include e-book, image/text editor, web browser, etc.

Although the above hardware Error Diffusion Encoders are embedded in display controllers, in some recent handheld architectures, such as OMAP™ 2 and Intel® PXA27X, part of the main memory may be allocated or mapped as a display frame buffer, and the data write is controlled by the memory controller and/or equivalent modules. In this case the Error Diffusion Encoder can be embedded in the memory controller or equivalent modules (e.g., chipset), besides some additional features such as the work mode switcher in the display controller.

In addition, according to one embodiment, an algorithm may be implemented within an error diffusion encoder for a color plane. As for color images with 3 color planes, the algorithm is similar for each plane. In one embodiment, an error diffusion algorithm is performed on each image pixel, in sequential order, starting from the top left pixel and proceeding from left to right to the bottom of the image. Alternatively, multiple encoders may be employed to process multiple color planes.

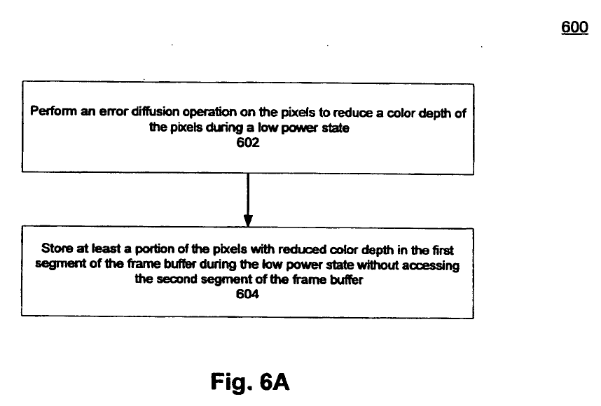

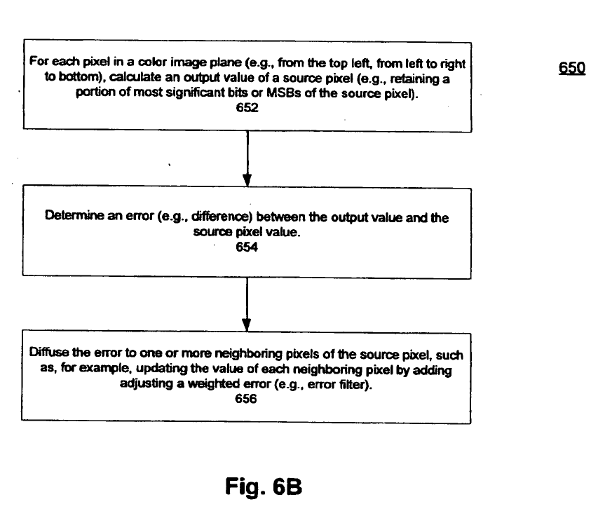

FIG. 6 is a flow diagram illustrating an example of a process for error diffusion according to one embodiment. Process 600 may be performed by a processing logic that may include hardware (circuitry, dedicated logic, etc.), software (such as is run on a general purpose computer system or a dedicated machine), or a combination of both. For example, process 600 may be performed by a display sub-system as shown in FIGS. 3-5.

Referring to FIG. 6A, at block 602, during a low power state, such as a low or reduced power state, an error diffusion operation is performed on the pixels to reduce a color depth of the pixels. At block 604, at least a portion of the pixels with reduced color depth is stored in a first segment of the frame buffer without accessing (e.g., writing or reading) the second segment of the frame buffer. As a result, during the low power state, the power to the second segment of the frame buffer may be reduced or shut off to save power. Other operations may also be performed. Note that a device can operate in the normal power state and the low power state independently and can switch from either power state to the other, for example, by hardware, software, or a combination of both at any time. Thus, one power state does not necessarily depend from the other power state or vice versa

FIG. 6B is a flow diagram illustrating an example of a process for error diffusion according to one embodiment. Process 650 may be performed by a processing logic that may include hardware (circuitry, dedicated logic, etc.), software (such as is run on a general purpose computer system or a dedicated machine), or a combination of both. For example, process 650 may be performed by a display sub-system as shown in FIGS. 3-5, particularly, as a part of operations involved in block 602 of FIG. 6A.

Referring to FIG. 6B, at block 652, for each pixel, an output value is calculated according to a source pixel value. In a particular embodiment, the output pixel value may include 2 to 3 most significant bits of the source pixel value. At block 654, the error between the source pixel value and the output pixel value is calculated. At block 656, the error may be diffused to the neighboring pixels (e.g., more than 4 pixels), including for example, updating the value of each neighboring pixel by adding a weighted error. The pattern in diffusing the error is also referred to as an error filter. Other operations may also be performed.

Typically, the classical error diffusion is a 2-dimensional-convolution-like algorithm with high computational complexity and intensively memory buffer accessing. For example, in a conventional algorithm, each pixel needs at least 8 times of memory accesses for diff-using the error to the 4 neighboring pixels. It also needs a memory buffer sized of two image rows to temporarily store the diffused error data. These cause a high cost and high power consumption of the Error Diffusion Encoder itself, which is unacceptable in a lower power technique for a portable device, such as a handheld device.

Accordingly, according to one embodiment, a simplified error diffusion algorithm is designed to solve this problem, which includes 2-Neighborhood Error Filter and Error-Bit-Reduction. In one embodiment, in a 2-Neighborhood Error Filter a 2-neighborhood error filter is utilized instead of the classical error filters, as shown below:

| | |
|---|---|
| x | ½ |
| ½ | |

As shown above, when the pixel X is processed, according to one embodiment, the error between the output color and the original color of X is only diffused into the right and bottom pixels, and the weight coefficients are set to ½ for isotropic diffusion and implementation convenience. Because the neighborhood pixels are reduced to 2, only one buffer sized of one image row is required to store the error diffused to the bottom pixel, and the error diffused to the right pixel can be temporarily stored in a register.

Note that although the above processes are performed from top to bottom and from left to right, if the image accessing order is different (e.g. from bottom left to top right), the neighboring pixel may be right and upper ones according to certain embodiments of the invention.

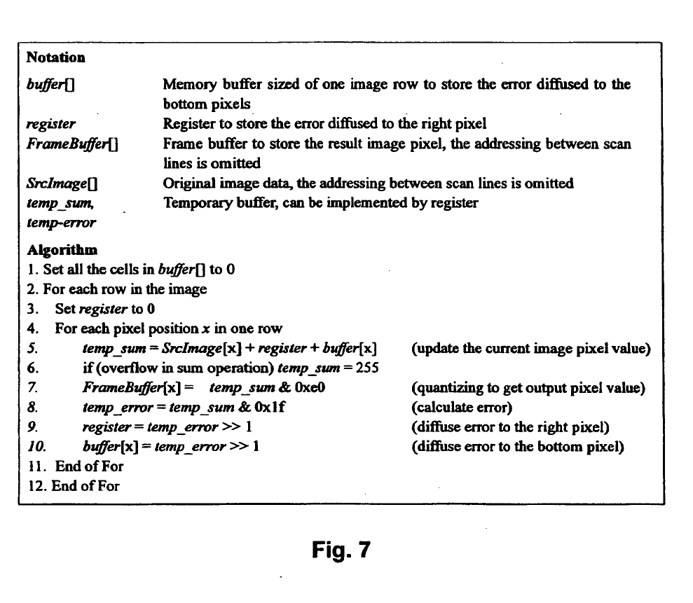

FIG. 7 shows the pseudo-code of an example process where the color depth is reduced from 8 bits to 3 bits. For example, the pseudo code may be performed by an error diffusion encoder described above. Referring to FIG. 7, in lines 5-6, the original pixel value in X and the weighted error diffused from the left and top pixels of X are summed and temporarily stored in a register temp_sum. In line 7, the output pixel value is calculated by cutting off the lower 5 bits (set to zero) of temp_sum, and is written into the frame buffer (e.g., Frame Buffer[x]). In line 8, the error between the modified original pixel and the output pixel, which is just the lower 5 bits of temp_sum, is calculated. In lines 9 and 10 the error is divided by 2 and stored in the buffer (e.g., buffer[x]) and the register (register) for the bottom pixel and right pixel respectively. Apparently, if we just consider the additional computation compared with image copy, the complexity for each pixel is roughly 2 times of ADD, 2 times of AND, 2 times of SHIFTING and one Conditional Evaluation operations. The additional memory access is also reduced to 2 times (e.g., read and write buffer[x] in lines 5 and 10).

In addition, according to one embodiment, besides the 2-neighborhood error filter, in hardware implementation, the error diffusion algorithm may be further simplified to reduce the buffer memory access that consumes most of the energy of the Error Diffusion Encoder. For example, suppose the 8-bit color depth being reduced to 3-bit, the bit number of error is 5, and is 4 after multiplying the weight coefficient of ½. The lower 3 bits may be cut down or truncated and only the higher 2 bits are reserved as the error data diffused to the right and bottom pixels. As a result, the memory access counted by bit is reduced.

Moreover, since the memory requirement is small (as for a 640×480 display, only 640×2 bits or 160 bytes are required for each color plane), the memory buffer can be cost-effectively realized by SRAM (static random access memory) that consumes much less energy than DRAM (dynamic RAM).

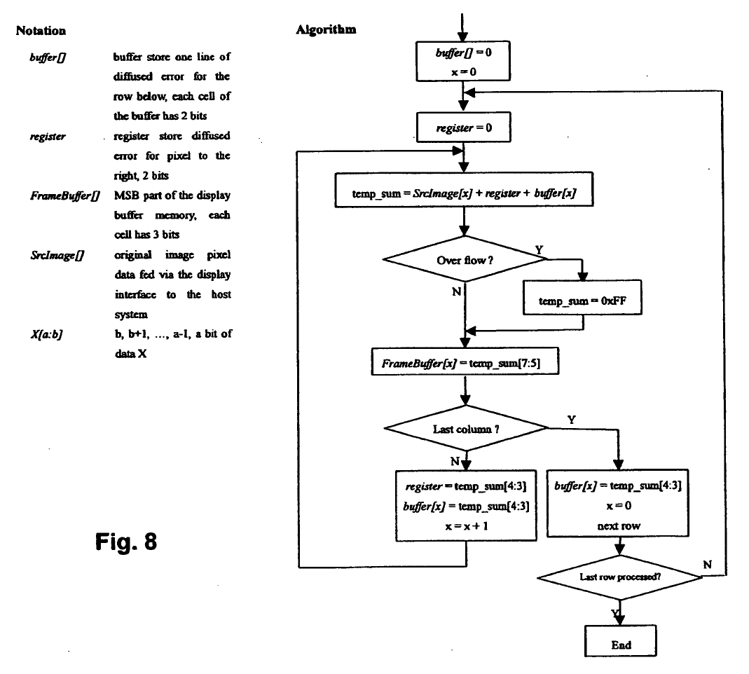

FIG. 8 is a flow diagram illustrating an example of a process of the error diffusion algorithm with a 2-neighborhood error filter and error-bit-reduction according to one embodiment. Note that the variable temp_sum here is just a symbol to illustrate the algorithm and is not the physical register or memory, temp_sum[7:5] denotes the data lines of bits 5, 6 and 7, and temp_sum[4:3] denotes the data lines of bits 3 and 4.

Compared with the software implementation, the hardware solution has less complexity and is more energy-efficient, because: (1) it is easy to make the register and buffer support 2-bit data access in hardware implementation, which is relatively difficult in software solution; (2) it does not need the temporary register and the SHIFTING operation unit in the hardware implementation. Instead, these two functions can be implemented by appropriately connecting the data lines. As a result, the hardware Error Diffusion Encoder only needs 2 times of 2-bit memory access and 2 times of 2-bit register access for each pixel, which consumes much less energy.

The above illustration is based on images with one color plane. As for color images (e.g. 24-bit true color image, 16-bit color image, etc.), the RGB sub-pixel data can be fed into the display system sub-pixel by sub-pixel or color plane by color plane in different display system configurations. For the former case, 3 copies of the Error Diffusion Encoder may be used to process the R, G and B sub-pixels independently. For the later case, one copy of the encoder may be used to process the R, G and B color plane sequentially. Other configurations may exist.

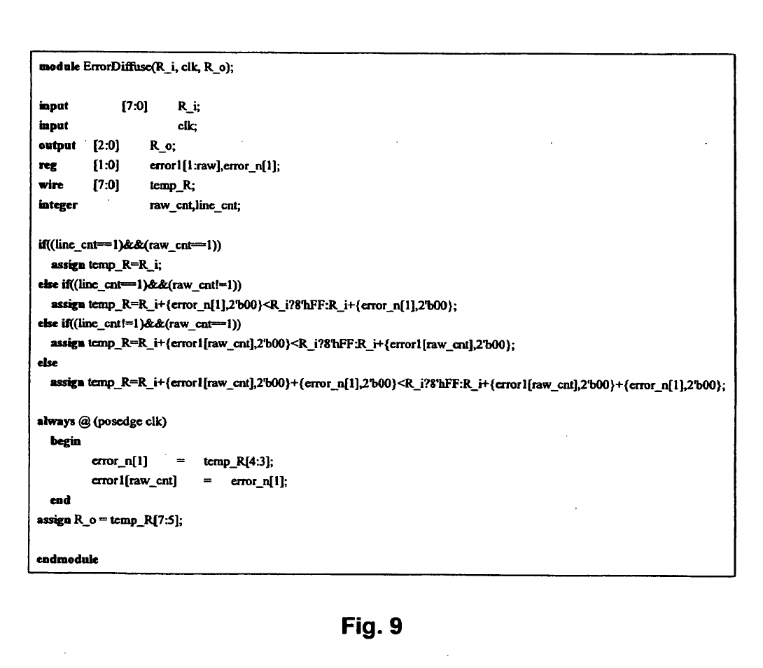

In a particular embodiment, an Error Diffusion Encoder is implemented in an XC3S400-FG320 of Xilinx Spartan series FPGA. According to one embodiment, the hardware pseudo-code for one color plane is shown in FIG. 9, in which the input 8-bit pixel data is encoded to 3-bit data.

As for the true color image with 3 color planes, a 24-bit image is fed into a frame buffer pixel by pixel, in which each pixel includes the B, G and R color data with 8 bits respectively. In this case, three copies of the Error Diffusion Encoders and the corresponding intern buffers are utilized. A block RAM in FPGA (defined in constrain file) is used to implement internal memory buffer to store the diffused error in one scan line. Block RAMs are dedicated blocks of true dual-port RAM. This kind of implementation saves power than FPGA's logic resources. The implemented frame rate is approximately 30 frame/second and the image size is 640×480 pixels. For the encoder core logic, only 3840 bits of block RAMs, 379 slices and 154 slice flip-flops, which have an equivalent gate count of 32,723 (including block RAMs) gates, are used.

Real image data is used for FPGA simulation to verify the proposed hardware Error Diffusion Encoder. The original image is 24-bit true color, after the Error Diffusion Encoder, the color depth is reduced to 9 bits with 3:3:3 for RGB. The simulation results show the hardware Error Diffusion Encoder outputs the same images as in the software experiments described above.

Due to the Error Diffuision Encoder is integrated in the LCD controller, the core logic of the additional encoder is useful for the power budget, thus the I/O part is not included. The error diffusion encoder core logic only consumes approximately 2.4 mW of power. By using one or more techniques described above, approximately ⅝ of frame buffer storage room can be saved and their power can be reduced or shut down. But consider that practical SDRAM frame buffer are 4, 8 or 16 bits wide, about ½ power can be saved for 4 bits wide frame buffer. For 16 Mbit frame buffer, about 8 Mbit's power consumption, can be saved. For example, if 16 Mbit SDRAM from Samsung, K4S161622E is used for frame buffer, its power consumption is 462 mW at operating mode and 231 mW power can be saved.

For equivalent capability, FPGA will consume about 20 times of power as that of an ASIC. If the error diffusion encoder is integrated directly into LCD controller by the ASIC, the power consumption will be reduced to 0.12 mW. At average, for 16 Mbit SDRAM K4S161622E, one bit will consume about 2.88×10-5 mW. The power of hardware error diffusion can be converted to about 4155 bits' power consumption in 16 Mbit SDRAM. For the error diffusion encoder described above, 8 Mbits of frame buffer's power can be saved at the expenses of 4 kbits power, the expenses is about 0.05% of saved frame buffer power.

Reducing pixel bit number from 24-bit to 9-bit by our proposed hardware Error Diffusion Encoder solution, we can not only save the power of frame buffer but also the ⅝ of power of frame buffer data bus and LCD panel bus. Based on the energy portion of conventional system component of hand-held embedded system, we can estimate the portion of total power saved by hardware error diffusion encoder (Due to the additional encoder power is only about 0.05% of saved frame buffer power, it's neglected in the estimation). The LCD panel bus is the type with 4-bit additional sync/control signal. The data is shown in table below. From the table below, we can see that about 10.57% of whole hand-held embedded system power can be saved by our proposed hardware Error Diffusion Encoder.

| | Display | Display | | |
|---|---|---|---|---|
| | memory | memory data | LCD | LCD |
| Component | device | bus | Panel bus | Controller |
| Power portion (%) | 13.2 | 3.2 | 5.8 | 3.4 |
| without encoder | | | | |
| Power portion (%) | 6.6 | 1.2 | 3.38 | 3.4 |
| with encoder | | | | |
| Saved portion (%) | 6.6 | 2 | 2.42 | 0 |

| | |
|---|---|
| Total saved portion | 10.57 |
| (%) | |

We only calculated the saved power portion for handheld devices with independent frame buffer chips. For that architecture with part of main memory mapped for display frame buffer, with hardware Error Diffusion Encoder Solution, the saved power on display memory data bus and LCD panel bus still remain.

Above are the implementation and analysis on encoding 24-bit color images to 9-bit ones. The hardware design is similar in dealing with the encoding from 24-bit images to 8-bit ones, from 16-bit images to 8-bit, from 16-bit to 9-bit, etc. Note that the above described techniques are applied to a color plane for the purposes of illustration. It is not so limited. It will be appreciated that the above described techniques may also be applied to grey scale image planes, where the grey scale image planes may be considered as a special kind of color planes.

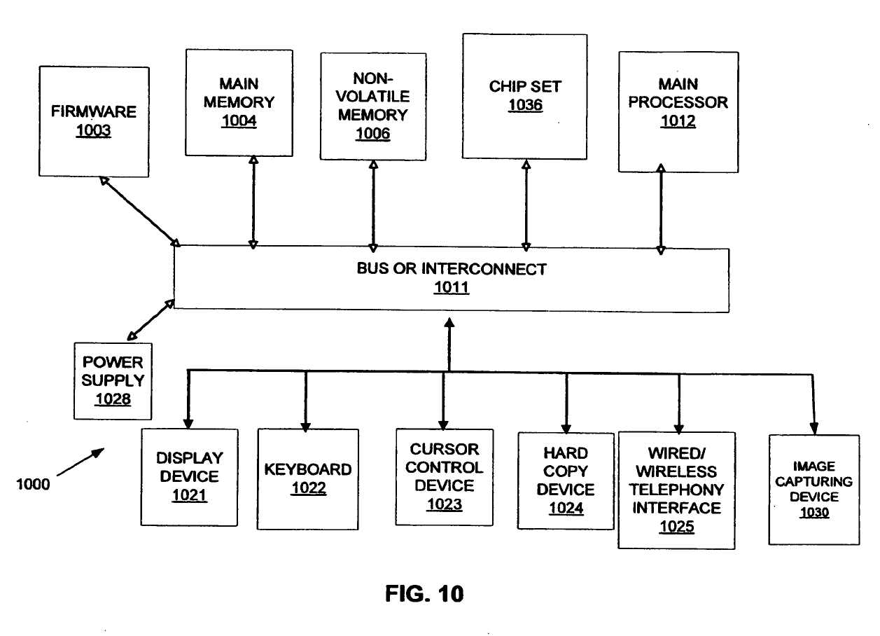

FIG. 10 is a block diagram of an example computer system that may use an embodiment of a display sub-system having at least one of the features described above, such as, for example, an error diffusion encoder as described above. In one embodiment, computer system 1000 includes a communication mechanism, interconnect, and/or bus 1011 for communicating information, and an integrated circuit component such as a main processing unit 1012 coupled with bus or interconnect 1011 for processing information. The main processing unit 1012 may include one or more processors or processing core logic working together as a unit.

Computer system 1000 further includes a random access memory (RAM) or other dynamic storage device 1004 (also referred to as a main memory) coupled to bus or interconnect 1011 for storing information and instructions to be executed by main processing unit 1012. Main memory 1004 may also be used for storing temporary variables or other intermediate information during execution of instructions by main processing unit 1012.

Firmware 1003 may be a combination of software and hardware, such as Electronically Programmable Read-Only Memory (EPROM) that has the operations for the routine recorded on the EPROM. The firmware 1003 may embed foundation code, basic input/output system code (BIOS), or other similar code. The firmware 1003 may make it possible for the computer system 1000 to boot itself.

Computer system 1000 may also include a read-only memory (ROM) and/or other static storage device 1006 coupled to bus or interconnect 1011 for storing static information and instructions for main processing unit 1012. The static storage device 1006 may store OS (operating system) level, also referred to system level, and application level software. Computer system 1000 may further be coupled to a display device 1021, such as a cathode ray tube (CRT) or liquid crystal display (LCD), coupled to bus 1011 for displaying information to a computer user. A chipset may interface with the display device 1021.

An alphanumeric input device (keyboard) 1022, including alphanumeric and other keys, may also be coupled to bus 1011 for communicating information and command selections to main processing unit 1012. An additional user input device is cursor control device 1023, such as a mouse, trackball, trackpad, stylus, or cursor direction keys, coupled to bus 1011 for communicating direction information and command selections to main processing unit 1012, and for controlling cursor movement on a display device 1021. A chipset may interface with the input output devices.

Another device that may be coupled to bus 1011 is a hard copy device 1024, which may be used for printing instructions, data, or other information on a medium such as paper, film, or similar types of media. Furthermore, a sound recording and playback device, such as a speaker and/or microphone (not shown) may optionally be coupled to bus 1011 for audio interfacing with computer system 1000. Another device that maybe coupled to bus 1011 is a wired/wireless communication capability 1025. Further, according to one embodiment, system 1000 includes an image capturing device 1030, such as, for example, a digital camera, a video camera, and/or a scanner, etc. The image capturing device 1030 may capture a stream of images and system 1000 may process the captured images using one or more techniques described above.

According to one embodiment, an error diffusion encoder having one or more of the algorithms described above maybe implemented within system 1000. For example, an error diffusion encoder may be implemented as application software, which may be stored in non-volatile memory 1006 and executed from main memory 1004 to process display data in one or more frame buffers and display the data in display device 1021. Alternatively, the error diffusion encoder may be implemented in firmware 1003 or a device driver (e.g., a display driver). Further, the error diffusion encoder may be implemented in hardware, such as, for example, a display controller, which may be implemented within chipset 1036 and/or processor 1012. The one or more frame buffers may be specifically allocated from memory 1004. Alternatively, the one or more frame buffers may be implemented as separate dedicated memory within the hardware and/or firmware, such as, for example, chipset 1036 and/or firmware 1003, or a combination of the above configurations. Other components may also be included.

Thus, methods and apparatuses for error diffusion for display frame buffer power saving have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of embodiments of the invention as set forth in the following claims. The specification and drawings are, accordingly, to be regarded in an illustrative sense rather than a restrictive sense.

What is claimed is:

1. A computer implemented method, comprising:
in a normal power state, directly storing pixels of a color plane of image data in a first segment and a second segment of a frame buffer;
in a low power state, performing an error diffusion operation on the pixels to reduce a color depth of the pixels, the normal and low power states are independent and switchable from each other, and
storing at least a portion of the pixels with reduced color depth in the first segment of the frame buffer without accessing the second segment of the frame buffer during the low power state.

2. The method of claim 1, further comprising reducing power to the second segment of the frame buffer during the low power state.

3. The method of claim 1, further comprising:
during the normal power state, fetching the pixels from the first and second segments of the frame buffer for display; and
during the low power state, fetching the pixels with reduced color depth from the first segment of the frame buffer for display without accessing the second segment of the frame buffer.

4. The method of claim 3, wherein the first segment is a most significant device (MSD) of the frame buffer and the second segment is a least significant device (LSD) of the frame buffer.

5. The method of claim 4, wherein during the low power state, pixels with reduced color depth are used as data associated with the MSD for display while a predetermined value is used as data associated with the LSD for display without accessing the LSD of the frame buffer.

6. The method of claim 1, wherein performing an error diffusion operation on the pixels comprises:
for each source pixel of each color plane of the image data, calculating an output value corresponding to a source pixel value of the source pixel according to a predetermined algorithm;
calculating an error between the output value and the source pixel value; and
diffusing the error to up to two neighboring pixels of the source pixel.

7. The method of claim 6, wherein the up to two neighboring pixels are a right pixel and a bottom pixel of the source pixel.

8. The method of claim 6, wherein diffusing the error to up to two neighboring pixels comprises adjusting pixel values of the up to two neighboring pixels with at least a portion of the error, wherein the portion of the error diffused to the neighboring pixel in an identical row is temporarily stored in a register and a portion of the error diffused to the neighboring pixel in a next row is temporarily stored in a line buffer.

9. The method of claim 6, further comprising reducing color bits of each pixel with reduced color depth to fit within the first segment of the frame buffer prior to storing each pixel in the first segment of the frame buffer.

10. The method of claim 9, wherein reducing color bits of each pixel with reduced color depth comprises:
for each pixel of a color plane, arithmetically adding the error diffused from up to two neighboring pixels to an original value of a pixel, and
storing a predetermined number of most significant bits (MSBs) of the output value in the first segment of the frame buffer.

11. The method of claim 1, wherein the error diffusion operation is performed by an encoder implemented within at least one of software, a display controller, and a chipset of a data processing system.

12. A machine-readable medium for storing instructions, when executed by a machine, cause the machine to perform a method, the method comprising:
in a normal power state, directly storing pixels of a color plane of image data in a first segment and a second segment of a frame buffer;
in a low power state, performing an error diffusion operation on the pixels to reduce a color depth of the pixels, the normal and low power states being independent and switchable from each other; and
storing at least a portion of the pixels with reduced color depth in the first segment of the frame buffer during the low power state without accessing the second segment of the frame buffer.

13. The machine-readable medium of claim 12, wherein performing an error diffusion operation on the pixels comprises:
for each source pixel of each color plane of the image data, calculating an output value corresponding to a source pixel value of the source pixel according to a predetermined algorithm;
calculating an error between the output value and the source pixel value; and
diffusing the error to up to two neighboring pixels of the source pixel.

14. The machine-readable medium of claim 13, wherein the method further comprises reducing color bits of each pixel with reduced color depth to fit within the first segment of the frame buffer prior to storing each pixel in the first segment of the frame-buffer, including
for each pixel of a color plane, arithmetically adding the error diffused from up to two neighboring pixels to an original value of a pixel, and
storing a predetermined number of most significant bits (MSBs) of the output value in the first segment of the frame buffer.

15. A data processing system, comprising:
a display subsystem including
a frame buffer having a first segment and a second segment, an encoder coupled to the frame buffer and configured to store pixels of a color plane of image data in the first and second
segments of the frame buffer during a normal power state, perform an error diffusion operation on the pixels to reduce a color
depth of the pixels during a low power state, the normal and low power states being independent and switchable from each other, and
store at least a portion of the pixels with reduced color depth in the first segment of the frame buffer during the low power state without accessing the second segment of the frame buffer.

16. The system of claim 15, wherein during performing an error diffusion operation on the pixels, the encoder is further configured to:
for each source pixel of each color plane of the image data, calculate an output value corresponding to a source pixel value of the source pixel according to a predetermined algorithm,
calculate an error between the output value and the source pixel value, and
diffuse the error to up to two neighboring pixels of the source pixel.

17. The system of claim 16, wherein the encoder is further configured to reduce color bits of each pixel with reduced color depth to fit within the first segment of the frame buffer prior to storing each pixel in the first segment of the frame buffer, including
for each pixel of a color plane, arithmetically adding the error diffused from up to two neighboring pixels to an original value of a pixel, and
storing a predetermined number of most significant bits (MSBs) of the output value in the first segment of the frame buffer.

18. A computer implemented method, comprising:
during a low power state of a frame buffer having a first segment and a second segment, for each source pixel of each color plane of image data, calculating an output value corresponding to a source pixel value of the source pixel according to a predetermined algorithm;
calculating an error between the output value and the source pixel value;
diffusing the error to up to two neighboring pixels of the source pixel; and
storing the output value of the source pixel and the diffused up to two neighboring pixels to the first segment of the frame buffer without accessing the second segment of the frame buffer during the low power state of the frame buffer.

19. The method of claim 18, further comprising reducing color bits of each output value and the up to two neighboring pixels to fit within the first segment of the frame buffer before being stored in the first segment of the frame buffer.

20. The method of claim 19, wherein reducing color bits comprises:
for each pixel of a color plane, arithmetically adding the error diffused from up to two neighboring pixels to an original value of a pixel, and
storing a predetermined number of most significant bits (MSBs) of the output value in the first segment of the fame buffer.
